(19) United States
(12) Patent Application Publication
(10) Pub. No.: US 2004/0003864 A1
(43) Pub. Date: Jan. 8, 2004

(54) Aerosol filling adapter

(76) Inventors: James A. Bloome, Blue Grass, IA (US); Daniel D. Manion, Hampton, IL (US)

Correspondence Address: WOOD, HERRON & EVANS, LLP, 2700 CAREW TOWER, 441 VINE STREET, CINCINNATI, OH, 45202, US

(21) Appl. No.: 10/189,065

(22) Filed: Jul. 3, 2002

(51) Int. Cl. B67C 3/00

(52) U.S. Cl. 141/20; 141/3

(57) ABSTRACT

An improved aerosol container filling adapter has a chamber seal engaging the bottom of a valve cup on the container. A chamber in the adapter is pressurized to open an aerosol valve and to fill the container. Pressure reduction in the chamber allows the aerosol valve to close, independent of the seal, and without content “spit-back”. Alternative structures and methods are disclosed.

### BACKGROUND OF THE INVENTION

This invention relates to filling of aerosol containers and more particularly to adapters for filling aerosol containers with gases.

When aerosol containers or cans are filled with whipped cream, for example, it has been desirable to inject the cans with precise amounts of nitrous oxide propellant which gives the cream a foamy quality. Typically, this is done through a filling adapter designed particularly for the style of aerosol valve or valve tip used in the can. It is advantageous to operatively seal the adapter to the valve stem, valve tip or stem island so that no (or only a little) gas is wasted during the injection process. In this regard, past adapters have usually sealed onto the can's valve stem, the valve tip which mounts on the stem or onto the projecting island through which the valve stem exits the can. These seals facilitate injection of the gas or propellant into the can.

While such systems have worked for years, they have certain inherent disadvantages to overcome. For example, one major disadvantage is that of “spit back”, where some of the cream is spit out of the valve stem and/or valve tip at the end of the gas injection process. In most, if not all, instances, this occurs where the fill is completed but the valve in the can is held open by the adapter, allowing the residual vapor pressure in the can to spit back cream. In particular, where the adapter seals on the valve tip or stem, for example, the can valve is held open at least momentarily at the end of the fill cycle by the adapter seal and the expanding whipped cream in the can spits out or sputters out. In order to meet sanitation requirements, the so-filled cans must be washed to remove all means from the actuator tips.

Accordingly, it has been one objective of the invention to provide an improved adapter for allowing gas injection yet obstructing “spit back” from an aerosol can or container.

Another objective of the invention has been to eliminate “spit back” in filling of aerosol cans.

Another objective of the invention has been to provide improved methods of filling aerosol cans without “spit back”.

### BRIEF SUMMARY OF THE INVENTION

To these ends, the invention in a preferred embodiment provides an adapter for filling an aerosol container wherein the adapter seals not to the valve stem, valve tip or valve island in the valve cup through which the stem extends, but rather onto the valve cup itself. Thus, neither the adapter nor its seal interferes with the valve stem or valve tip and the corresponding valve is not in any way impeded from closing when the filling cycle ends.

Specifically, this is accomplished by an improved adapter having a seal which is presented to a portion of the container or can such as the base of the valve cup structure on the end of the aerosol can. Typically, the valve cup is of pressed metal in cup-shaped configuration and defining on its center the valve island or boss-like projection through which the valve stem protrudes. Ideally, the can aerosol valve is disposed within the valve island.

In use, the adapter according to the invention has an end seal which seals on the floor of the valve cup. The head space defined by the adapter above the valve is pressurized with the desired gas or propellant. This pressure forces the aerosol valve open, allowing filling to begin.

Preferably, the gas or propellant is supplied to the adapter from a metering cylinder which precisely controls the quantity of propellant being filled. When the piston of the metering cylinder completes its injection stroke, the pressure inside the aerosol can and the pressure above the valve in the adapter will be equalized and the spring-loaded aerosol valve will immediately close. The aerosol valve is free to close immediately on pressure equalization since there is no interference with the valve tip or valve stem by any seal of the adapter. This action prevents “spit-back” of the cream after propellant filling, eliminating the need for cleaning the container before final packing.

In addition to avoidance of “spit-back”, the invention herein provides a yet further advantage. Specifically, it allows filling of aerosol cans with many different valve stem and valve tip configurations with the same universal adapter. Prior to the invention, the adapters generally were required to conform., at least in their seal structure, to the specific configuration of the valve stem or valve tip. According to the invention, the seal is accomplished on the floor of the valve cup of the container which is generally uniform across a wide variety of aerosol applications independent of the specific stem or tip structures used. One adapter design then, according to the invention, has widely varying applications across a wide range of aerosol valve stems and tips.

Moreover, it will be appreciated that the preferred embodiment of the adapter according to the invention can be modified to seal on the curl, sides or other bottom structure of the valve cap while still providing the benefits and advantages noted above.

These and other advantages and modifications will be readily apparent from the following detailed description of a preferred embodiment of the invention, and from the drawings in which:

### BRIEF DESCRIPTION OF THE DRAWINGS

FIG. 1 is a cross-sectional view of a preferred embodiment of an adapter according to the invention;

FIG. 2 is a cross-sectional view of the adapter of FIG. 1 showing lowering of the adapter of FIG. 1 toward a filling position with the poppet being opened by the motion;

FIG. 3 is a cross-sectional view of the adapter of FIG. 2 showing the condition of the adapter upon filling with the aerosol valve tip depressed by filling pressure and the aerosol valve opened;

FIG. 4 is a cross-sectional view of the adapter of FIG. 3 showing the end of the filling cycle with poppet valve still open, but the valve tip released upwardly to close the aerosol valve;

FIG. 5 is a cross-sectional view of a prior art adapter in a position corresponding to that of the adapter in FIG. 1;

FIG. 6 is a cross-sectional view of the prior art adapter of FIG. 5, but showing the adapter in a position corresponding to that of the adapter of FIG. 4, but with the valve tip still held in a depressed condition; and

FIG. 7 is a cross-sectional view like FIG. 6, but showing the aerosol valve clogged upon pressure equalization even though the poppet is open.

### DETAILED DESCRIPTION OF THE INVENTION

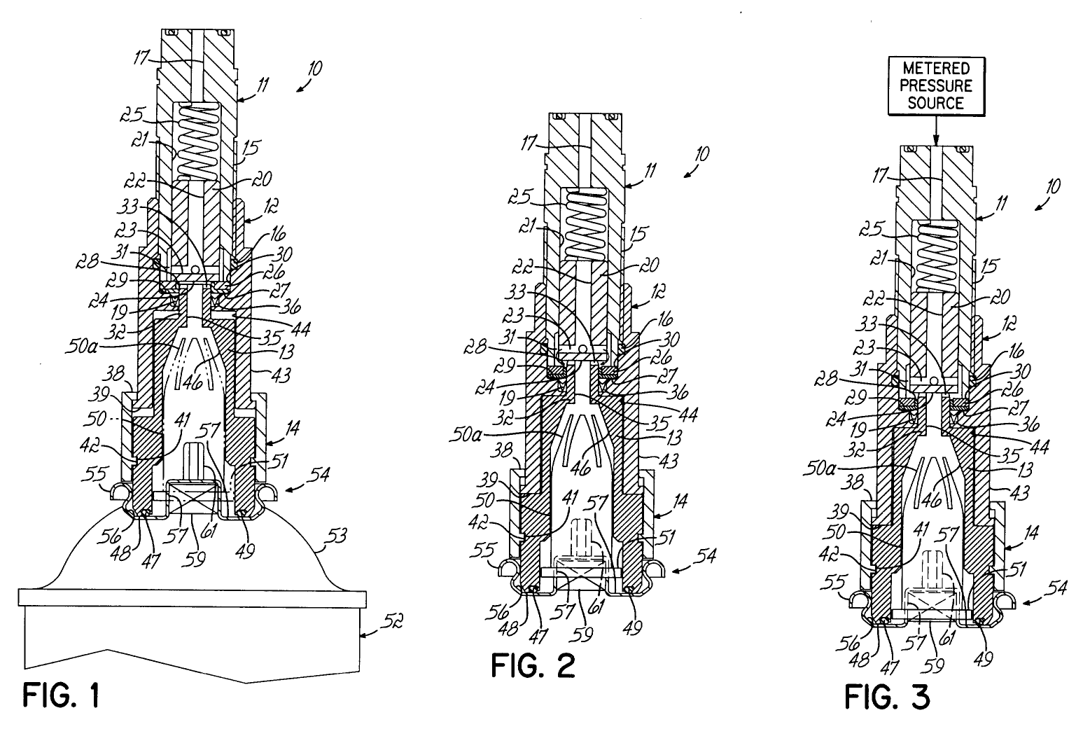

Turning now to the drawings, there is shown in FIGS. 1-4 a preferred embodiment of an adapter 10 according to the invention. Adapter 10 includes an adapter holder 11, adapter housing 12, an adapter body 13 and a retainer 14. The holder 11 is mounted in housing 12 by means of cooperating threads 15, and an O-ring seal 16 seals holder 11 and housing 12.

A spring-biased poppet valve 20 is disposed in bore 21 of holder 11. Poppet 20 includes a gas passage 22 and transverse gas passages 23 communicating with passage 22.

A teflon seal 26 is disposed on an annular seal retainer 27 having a circular projection 28 supporting seal 26. Retainer 27 is mounted on shoulder 29 in bore 30 of housing 12.

Poppet face 24 of poppet 20 removably seals on seal 26 as shown in FIG. 1, from pressure by poppet spring 25, so that no gas pressure above the poppet 20 can flow therepast.

Adapter body 13 includes a poppet engaging projection 32 having relieved areas 33 (FIG. 3). As will be described, poppet 20 can be unseated from seal 26, against the bias of spring 25, by motion of body 13 and projection 32 against the poppet 20. When the face 24 of poppet 20 is lifted from seal 26, pressurized gas in bore 21 above the poppet can flow through passages 22, 23 and enlarged annular chamber 31 in bore 21 of housing 12, around face 24, between face 24 and seal 26, through relieved areas and into open bore 35 of projection 32. If desired, a seal 19 can be used between projection 32 of the housing 12 to prevent gas leakage therearound (i.e. in seal area 36).

Retainer 14 has an inwardly turned flange 38 fitting over flange 39 of housing 12 to prevent its separation therefrom. Retainer 14 also has an internal inwardly directed circular flange 41 fitting in groove 42 of body 13 to secure it to housing 12. At the same time, flange 38 can ride on outer surface 43 of housing 12 so the body 13 can be moved in a direction into the bore 44 of housing 12 toward poppet 20.

The interior wall or bore 46 of body 13 is preferably shaped similarly to a valve tip 50 extending from an aerosol can as will be described. Preferably interior bore 46 of body 13 closely conforms to the shape and size of anticipated tip 50, but it will be appreciated bore 46 can accommodate many tip sizes and configurations. The closer the shape and size of bore 46 to the tip, the less headspace for excess gas, a desirable feature.

A seal, such as an O-ring seal 47, is disposed in an end face 48 of body 13. End face 48 defines a groove 49 for seal retention.

It will be appreciated that adapter 10 is mounted on a gas filling apparatus (not shown) provided with a metered pressure source of any suitable manufacture for pressurizing the adapter 10 with a precise volume of gas at a defined pressure for filling aerosol containers. The adapter 10, for example, is mounted via holder 11 in or on a reciprocating apparatus for moving the adapter toward an aerosol container, holding the adapter 10 for movement of an aerosol container toward the adapter 10. Of course, the source of pressurized gas is operably connected to bore 17, in holder 12, communicating with bore 21.

Adapter 10 is useful in filling aerosol containers or cans with pressurized gas for propellant or other applications, such as foaming of the container contents such as whipped cream. In particular, an aerosol container or can 52 is illustrated in FIG. 1. Can 52 has a domed top 53 and a valve cup 54. Valve cup 54 includes a circumferential curl 55, interior sides or walls 56, a bottom wall 57 and a central projection, boss or “island” 58. An aerosol valve 59 (not shown in detail), is typically disposed at least partially within the island 58 and is provided with a valve stem 61 extending therefrom through island 58. Valve stem 61 carries valve tip 50 which can be pushed downwardly toward aerosol valve 59 to open the valve via movement of stem 61.

It will be appreciated that tip 50 may typically have a circumferential flange or skirt 51 surrounding the island 58 and movable or reciprocable thereon. So, as tip 50 is urged toward aerosol valve 59 (FIG. 3), skirt 51 moves over the island 58 as illustrated in the Figs. Of course, tip 50 has a slotted end 50a for dispensing of the contents, such as whipped cream, therefrom under the pressure of a propellant such as a gas. Nitrous oxide (NO) is typically used: it also promotes foaming of the whipped cream product.

Operation of the invention is illustrated in the sequence of FIGS. 1-4. In FIG. 1, the adapter 10 is placed onto a can 52 either by introduction of the adapter 10 to the can 52 or of the can 52 to the adapter 10. Typically, cans 52 are introduced to a carousel (not shown) of mounted adapters 10 which are sequentially urged toward the cans 52.

As the adapter 10 is moved onto the valve cup 54, seal 47 engages the bottom wall 57 of cup 54 and seals against that wall. End face 48 forms a stop, engaging wall 57 to limit compression of the seal so it is not overly stressed. At the same time, it will be appreciated that tip 50 has been received in bore 46 freely (FIG. 2), and without such engagement as would move tip 50 to open the aerosol valve 59 in can 52. Thus, the lower end of the adapter is sealed to the valve cup bottom wall 57. Alternately, the seal 47 could be positioned on the lower end of body 13 so that it sealed onto the side wall 56 or on curl 55 of the cup 54. Given enough room, it may even be alternately sealed onto island 58. Preferably the seal is accomplished on bottom wall 57 as shown.

After sealing, the adapter 10 is pushed toward the can 52. See FIG. 2. Since the body 13 is stopped from further motion by end face 48, the housing 12 continues to move toward the can 52. This motion urges plate 24 of poppet 20 onto the upper relieved end of projection 32. Continued motion overcomes the bias of spring 25 and the poppet is moved off seal 26 (FIG. 2). This effectively opens chamber 31 to bores 23 and 22 of poppet 20, and through them to open bores 21 and 17 of holder 11.

Comparing FIGS. 2 and 3 it will be appreciated that body 13 is fully seated in both, yet tip 50 in FIG. 2 is not yet depressed to open valve 59. FIG. 3 shows tip 50, depressed by pressure, to open valve 59.

When a preferably precise metered volume of a gas propellant such as Nitrous Oxide (NO) is metered into passage 17 and thus to chamber 31 and into bore 46 of body 13, the pressure in bore 46 is sufficient to move valve tip 50 (and thus stem 61) toward the aerosol valve 59 to open it so the gas is injected through valve 59 into can 52. Propellant fill is thus initiated as illustrated in FIG. 3.

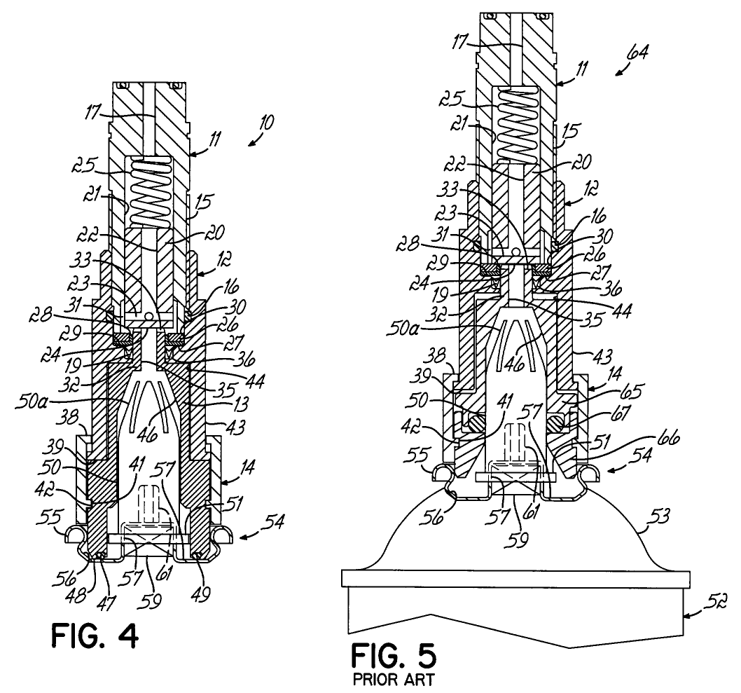

Once the pressure above adapter 10 and in can 52 is equalized, the filling is complete. At this time, gas pressure differential is lost, and the spring biased aerosol valve 59 closes, preventing any back flow or “spit back” of its contents, even though poppet 2 is still open (the metered gas pressure is now equalized) (FIG. 4). In FIG. 4, it will be appreciated that the spring bias of aerosol valve 59 is sufficient to raise tip 50 in chamber 46, the pressure being equalized, to close the valve 59. There is no seal drag on tip 50, and no spit-back. The adapter is then lifted from the can 52, closing poppet 20 for a repeat operation on a subsequent can 52.

A significant benefit of the above described invention can be appreciated from an understanding of the prior art adapter 64 as depicted in FIGS. 5-7. In these Figs., components similar to those of the above described invention are identified by the same numbers, while different components have different numbers. In essence, the major differences lie in the adapter body which, in the prior art, is defined by two separate members, upper body 65 and lower body 66. An O-ring seal 67 is oriented between the two components 65, 66 of the adapter body.

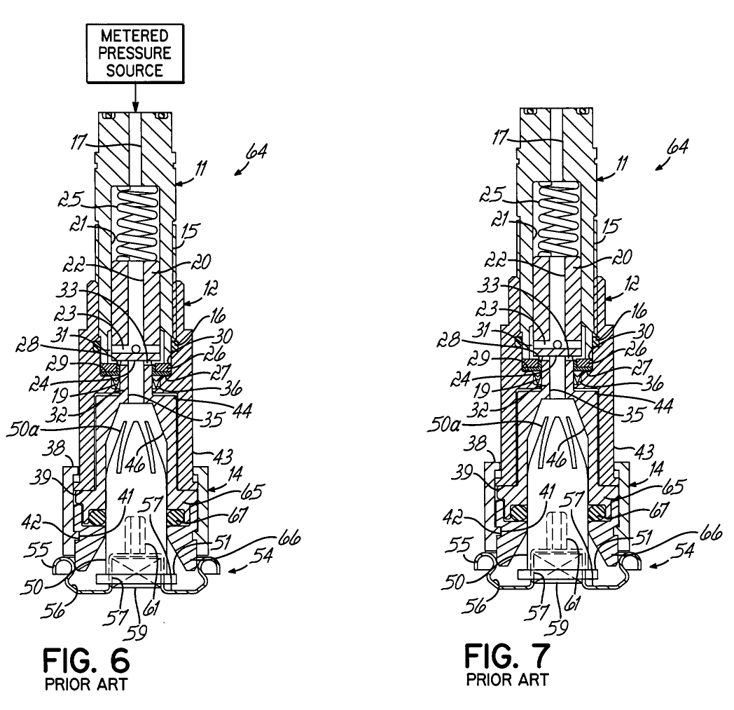

In use, when the adapter 64 is introduced to a valve cup 54 (FIG. 5), the lower adapter member 66 and/or retainer ring 14 engage the valve cup 54. Further motion toward the valve cup causes upper adapter body 65 to move toward lower adapter body 66, squeezing seal 67 against valve tip 50 and sealing the adapter, not to the valve cup 54, but to tip 50 (FIG. 6). Continued motion down plus the pressure of the propellant introduced into the adapter, moves tip 50 down to open aerosol valve 59 for filling (FIG. 6). Once poppet 20 opens and the desired propellant is injected through the adapter 64, pressure is equalized. Since, however, seal 67 is effected against the tip 50, it drags on the tip 50 and the tip 50 is not free to move and is held in its downwardly position, holding open valve 59, even though the adapter is slightly retracted poppet 20 is seated (FIG. 7). This is evident in FIG. 7 showing the continued depressed state of tip 50. Contents of can 52 now mixed with propellant, spits back through valve 59 and out of tip 50 until the adapter 64 is further lifted away from tip 50, releasing it from seal 67 and allowing valve 59 to close. Thereafter, the tip 50, valve cup 54 and/or can 52 must be cleaned before final packing.

Accordingly, it will be appreciated that the invention seals, not on tip 50, but on valve cup 54 and avoids spit-back. Moreover, since the seal is not required on the tip 50 which is more likely to vary in configuration than the valve 54, the adapter 10 of the invention is capable of serving a wide range of aerosol filling operations, without modification, to accommodate varied tip configuration and size.

These and other alterations and modifications will become readily apparent to those of ordinary skill in the art without departing from the scope of the invention and applicant intends to be bound only by the claims appended hereto.

We claim:

1. An aerosol filling adapter for use in filling an aerosol container having a valve cup therein, and through an aerosol valve, with gas, said adapter comprising:
an adapter housing;
a reciprocal adapter body in said housing;
an adapter holder mounted on said adapter housing;
an adapter valve in said holder, disposed for opening and closing in response to movement of said adapter body:
a seal on said adapter body;
said seal oriented for sealing engagement on said valve cap of an aerosol container in non-interfering relation with said aerosol valve.

2. An adapter as in claim 1 wherein said adapter body is a single, unitary member having a lower end face, and wherein said seal is disposed operatively at least proximate said face for engagement with said valve cup.

3. An adapter as in claim 2 wherein said end face comprises a stop surface for engagement with said valve cup, said stop limiting compression of said seal on said valve cup.

4. An adapter as in claim 3 wherein said end face and said seal are oriented for engagement with a floor of said valve cup.

5. An adapter as in claim 1 wherein said adapter body has a chamber for receiving an aerosol valve operating member, and wherein pressure in said chamber is operational to move said valve operating member and open said aerosol valve.

6. An aerosol filling adapter for filling an aerosol container with gas through an aerosol valve mounted on said container and having an aerosol valve operating member operably connected thereto, said adapter comprising:
an adapter body for isolating said member from ambient pressure and defining a pressure chamber for pressurizing said member to move said member and open said valve for filling said container with gas;
said adapter body having a seal for engaging a portion of said containers spaced from said member and sealing said chamber from ambient pressure, said portion of said container comprising a portion of a valve cup independent and spaced from said valve operating member.

7. An adapter as in claim 6 wherein said portion of said valve cup is spaced from a valve island defined by said cup.

8. An adapter as in claim 7 wherein said portion of said valve cup is a bottom thereof.

9. A method of filling an aerosol container having a valve cup comprising a curl, sides and bottom, with gas through an aerosol valve of said container, said method comprising the steps of:
engaging an adapter with said valve cup and sealing a chamber in said adapter with said seal;
supplying pressurized gas to said adapter and through said adapter to said container aerosol valve;
opening said aerosol valve with said pressure;
filling said container with gas;
ceasing said gas supply; and
closing said aerosol valve as a function of reduced pressure in said gas without “spit-back” of contents of said container.

10. A method as in claim 9 including the steps of sealing said chamber on at least one of a side, curl or bottom of said valve cup.

11. A method as in claim 10 including the further steps of sealing said chamber on a bottom portion of said valve cup.

12. A method of filling propellant into an aerosol container having a valve and a valve actuating member, said method comprising the steps of:
applying pressurized propellant to said valve actuating member, opening said valve in response to said application of pressure and injecting propellant into said container;
equalizing pressure of said propellant in and out of said container;
once said container is filled with a selected propellant; and
closing said valve in direct response to equalizations of pressure of said propellant.

13. A method as in claim 12 including the steps of:
applying pressurized propellant to said valve actuating member through an adapter sealed to a portion of said container;
operating said valve actuating member by the application of pressure thereto and independent of said seal.
